(19) United States
(12) Patent Application Publication
(10) Pub. No.: US 2025/0226544 A1
(43) Pub. Date: Jul. 10, 2025

(54) CONDUCTIVE MODULE

(71) Applicant: YAZAKI CORPORATION, Tokyo (JP)

(72) Inventors: Katsunori Sato, Makinohara-shi (JP); Tatsuya Oga, Makinohara-shi (JP); Mariko Nakagawa, Makinohara-shi (JP); Masato Tanaka, Makinohara-shi (JP); Daiki Tanaka, Fujieda-shi (JP)

(21) Appl. No.: 19/002,726

(22) Filed: Dec. 27, 2024

(30) Foreign Application Priority Data
Jan. 9, 2024 (JP) 2024-001307

(51) Int. Cl. H01M 50/507; H01M 50/262; H01M 50/30; H01M 50/519

(52) U.S. Cl. CPC H01M 50/507; H01M 50/262; H01M 50/30; H01M 50/519

(57) ABSTRACT

A conductive module includes a bus bar assembly component including bus bars that are physically and electrically connected to electrode terminals of battery cells, and a bus bar holding portion that holds a plurality of the bus bars, in which the bus bar assembly component that matches a specification of the battery module to be connected is assembled to the battery module from among a plurality of types prepared according to the specification of the battery module; and a circuit conductor assembly component including a circuit conductor for each of the bus bars, in which the circuit conductor assembly component that matches the specification of the battery module to be connected is assembled to the battery module from among a plurality of types prepared according to the specification of the battery module.

### CROSS-REFERENCE TO RELATED APPLICATION(S)

The present application claims priority to and incorporates by reference the entire contents of Japanese Patent Application No. 2024-001307 filed in Japan on Jan. 9, 2024.

### BACKGROUND OF THE INVENTION

### 1. Field of the Invention

The present invention relates to a conductive module.

### 2. Description of the Related Art

A conductive module is a wiring module that electrically connects a battery module in which a plurality of battery cells are arranged and a battery monitoring unit that monitors a battery state of the battery cells. The conductive module includes bus bars that are physically and electrically connected to electrode terminals of one or a pair of battery cells of the battery module, a circuit conductor for each bus bar that electrically connects the bus bars to the battery monitoring unit, and an electrical connection component that physically and electrically connects the bus bars to the circuit conductor. The conductive module is assembled to the battery module to configure a battery pack together with the battery module. This type of conductive module is disclosed in, for example, Japanese Patent Application Laid-open No. 2022-74179.

The battery module includes an exhaust duct that communicates with an exhaust valve of each battery cell and releases a gas inside the battery cell discharged from the exhaust valve to an atmosphere. In addition, the battery module includes a restraint member that restrains respective battery cells in an arranged state. Conventionally, in the battery pack, even when the same number of same battery cells are arranged, battery modules of various specifications are used such that a shape and arrangement of the exhaust duct are different, or a shape and arrangement of the restraint member are different. Therefore, conventionally, a conductive module whose specification is changed for each specification of the battery module is prepared, and this is one of hindrance factors in reducing cost.

### SUMMARY OF THE INVENTION

Therefore, an object of the present invention is to provide a conductive module capable of reducing cost.

In order to achieve the above mentioned object, a conductive module according to one aspect of the present invention includes a bus bar assembly component including bus bars that are physically and electrically connected to electrode terminals of one or a pair of battery cells of a battery module in which a plurality of the battery cells are arranged, and a bus bar holding portion that holds a plurality of the bus bars, wherein the bus bar assembly component that matches a specification of the battery module to be connected is assembled to the battery module from among a plurality of types prepared according to the specification of the battery module; and a circuit conductor assembly component including a circuit conductor for each of the bus bars that electrically connects the bus bars to a battery monitoring unit, wherein the circuit conductor assembly component that matches the specification of the battery module to be connected is assembled to the battery module from among a plurality of types prepared according to the specification of the battery module.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a conductive module according to an embodiment;

FIG. 2 is a perspective view illustrating one of combinations in the conductive module of the embodiment;

FIG. 3 is a perspective view illustrating one of combinations in the conductive module of the embodiment;

FIG. 4 is a perspective view illustrating one of combinations in the conductive module of the embodiment;

FIG. 5 is a perspective view illustrating one of combinations in the conductive module of the embodiment;

FIG. 6 is a perspective view illustrating one of specifications of a battery module;

FIG. 7 is a perspective view illustrating an example of a combination of a conductive module assembled to the battery module of FIG. 6;

FIG. 8 is a perspective view illustrating one of specifications of a battery module;

FIG. 9 is a perspective view illustrating an example of a combination of a conductive module assembled to the battery module of FIG. 8;

FIG. 10 is a perspective view illustrating one of specifications of a battery module;

FIG. 11 is a perspective view illustrating an example of a combination of a conductive module assembled to the battery module of FIG. 10; and

FIG. 12 is a perspective view illustrating an example of a conductive module assembled to the battery module of FIG. 10.

### DETAILED DESCRIPTION OF THE PREFERRED EMBODIMENTS

Hereinafter, an embodiment of a conductive module according to the present invention will be described in detail with reference to the drawings. Note that the present invention is not limited by the embodiment.

### Embodiment

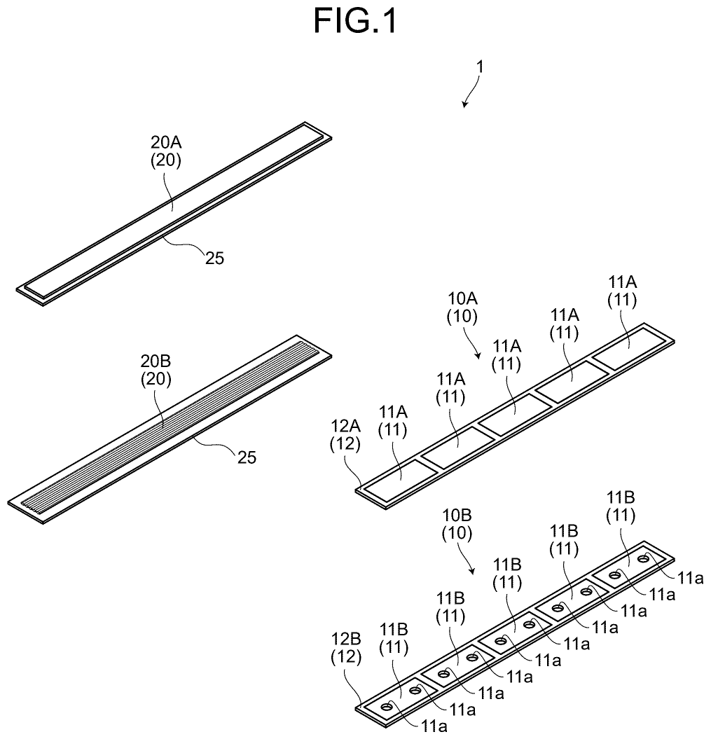

One of embodiments of a conductive module according to the present invention will be described with reference to FIGS. 1 to 12.

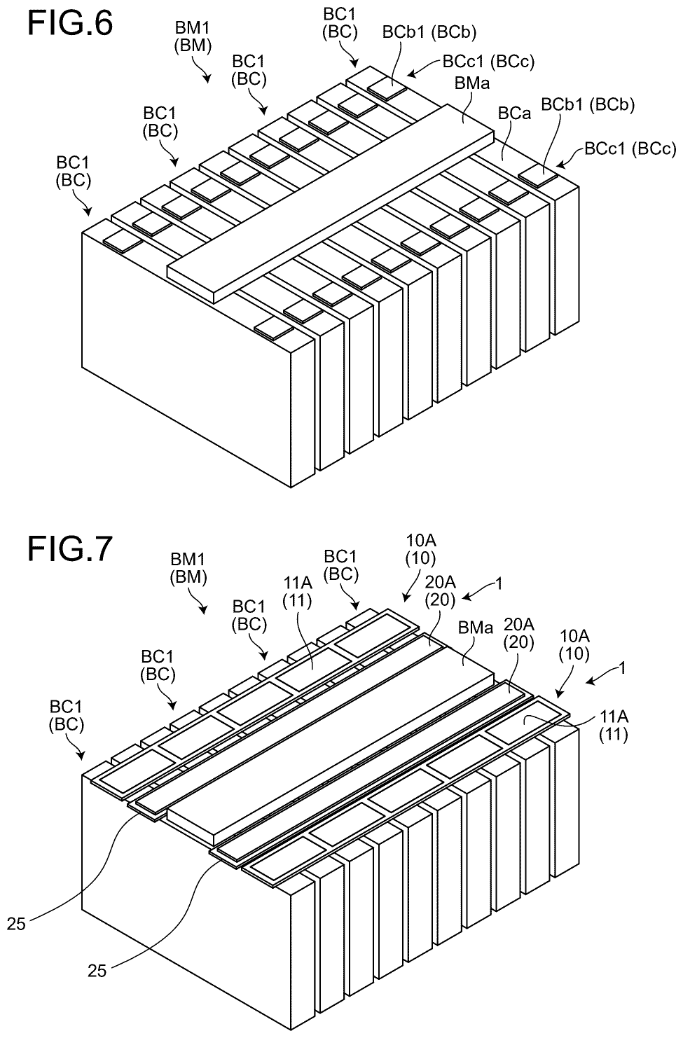

Reference numeral 1 in FIGS. 1 to 5 denotes a conductive module of the present embodiment. A conductive module 1 is assembled to a battery module BM (FIGS. 6 to 9) in which a plurality of battery cells BC are arranged (for example, arranged in a single row), and the battery module BM is electrically connected to a battery monitoring unit (not illustrated), so that the battery monitoring unit monitors the battery state of the battery cells BC. The conductive module 1 configures a battery pack together with the battery module BM (FIGS. 7 and 9). The battery pack is mounted on, for example, a vehicle (BEV: battery electric vehicle, HEV: hybrid electric vehicle, and the like) including a rotary machine as a drive source, and is used for power supply to the rotary machine.

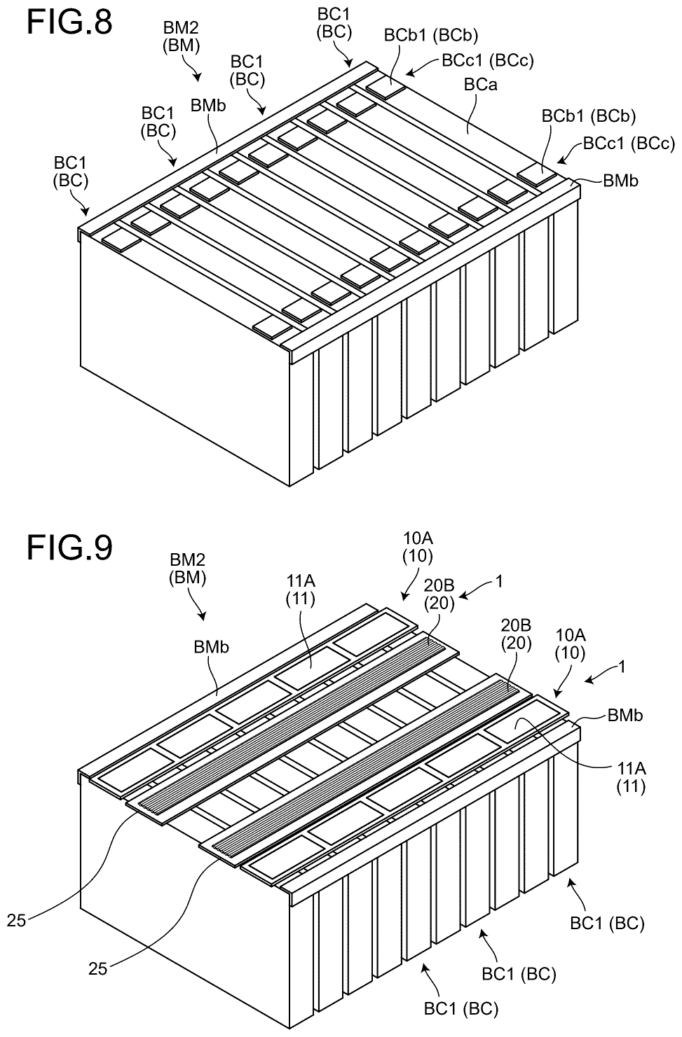

The battery cell BC includes a cell body BCa and positive and negative electrode terminals BCb (FIGS. 6 and 8). In the battery cell BC illustrated here, the cell body BCa is formed in a rectangular parallelepiped shape having six outer wall surfaces. In the plurality of battery cells BC configuring the battery module BM, the cell bodies BCa adjacent to each other in an arrangement direction are arranged with one outer wall surfaces facing each other. The battery module BM includes one-side electrode terminal group BCc in which one-side electrode terminals BCb in the respective battery cells BC are arranged along the arrangement direction, and the other-side electrode terminal group BCc in which the other-side electrode terminals BCb in the respective battery cells BC are arranged along the arrangement direction.

Here, the battery module BM has, for example, a plurality of specifications with different arrangements and shapes of the electrode terminals BCb. For example, in a battery module BM1 illustrated in FIG. 6 and a battery module BM2 illustrated in FIG. 8, each battery cell BC1 includes positive and negative flat plate-shaped electrode terminals BCb1 on one of the six outer wall surfaces of the cell body BCa. Therefore, in the battery modules BM1 and BM2, two electrode terminal groups BCc1 are provided on one plane (hereinafter, referred to as an “electrode installation surface”). The electrode terminals BCb1 physically and electrically connect bus bars 11 to be described later by welding or the like. Although not illustrated here, as the battery module BM, there is also a battery module having a specification in which the electrode terminal BCb is formed in a pole shape having a male screw portion.

Further, the battery module BM may include an exhaust duct BMa that communicates with an exhaust valve of each battery cell BC and releases a gas inside the battery cell BC discharged from the exhaust valve to an atmosphere. The battery module BM has a plurality of specifications with different arrangements and shapes of the exhaust duct BMa. In the battery module BM1 of FIG. 6, the exhaust duct BMa is disposed between two electrode terminal groups BCc1 as an example of the specification including the exhaust duct BMa.

Further, some of the battery module BM includes a restraint member BMb that restrains the respective battery cells BC in the arranged state. The battery module BM has a plurality of specifications with different arrangements and shapes of the restraint member BMb. In the battery module BM2 of FIG. 8, the restraint member BMb is provided for each electrode terminal group BCc1 as an example of the specification including the restraint member BMb. The restraint member BMb extends in the arrangement direction of the electrode terminals BCb1 of the electrode terminal group BCc1, and holds and restrains the respective battery cells BC1 at a boundary portion between an electrode installation surface of the battery module BM2 and a wall surface (hereinafter, referred to as a “side wall surface”) connected to intersect with the electrode installation surface.

As described above, the battery module BM has various specifications. The conductive module 1 of the present embodiment is configured as follows to be adapted to the battery module BM of the plurality of specifications.

The conductive module 1 includes a bus bar assembly component 10 including bus bars 11 that are physically and electrically connected to the electrode terminals BCb of one or a pair of battery cells BC of the battery module BM and a bus bar holding portion 12 holding the plurality of bus bars 11 (FIGS. 1 to 5). In the drawing, for convenience, only the bus bars 11 physically and electrically connected to the electrode terminals BCb of the pair of battery cells BC are illustrated.

The bus bar 11 is a plate-like conductive component made of metal, and is press-molded using, for example, a metal plate as a base material. The bus bar 11 illustrated here is formed in a rectangular flat-plate shape.

The bus bar holding portion 12 is formed of an insulating material such as a synthetic resin. The bus bar holding portion 12 is formed flat in a form in which a welded portion with the electrode terminals BCb on one plane of the bus bars 11 and, for example, a laser irradiation portion when performing a welding operation with respect to the electrode terminals BCb on the other plane of the bus bars 11 are exposed. The bus bar holding portion 12 illustrated here is, for example, insert-molded by pouring a liquid synthetic resin material into a mold in which the respective bus bars 11 are arranged.

A plurality of types of the bus bar assembly components 10 are prepared according to the specification of the battery module BM, and a bus bar assembly component that matches the specification of the battery module BM to be connected is assembled to the battery module BM from among the plurality of types.

For example, a bus bar assembly component 10A illustrated in FIGS. 1 to 3 is connected to the electrode terminals BCb1 of the electrode terminal group BCc1 included in the battery module BM1 of FIG. 6 or the battery module BM2 of FIG. 8 (FIGS. 7 and 9). Therefore, the bus bar assembly component 10A includes a plurality of rectangular bus bars 11A having a size corresponding to the electrode terminals BCb1 of the electrode terminal group BCc1, and the respective bus bars 11A are held by a bus bar holding portion 12A formed by insert molding.

The bus bar assembly component 10A can be applied to a battery module BM of another specification as long as the battery module BM includes the electrode terminal group BCc1 as in the battery module BM1 of FIG. 6 or the battery module BM2 of FIG. 8. That is, in this case, the bus bar assembly component 10A is a shared bus bar assembly component that can be shared by the battery modules BM of the plurality of specifications including the electrode terminal group BCc1. Therefore, when such a bus bar assembly component 10A is shared among the battery modules BM of the plurality of specifications, in the conductive module 1, the plurality of types of bus bar assembly components 10 include the bus bar assembly component 10A as the shared bus bar assembly component. In the conductive module 1, the bus bar assembly component 10 may be configured only by the bus bar assembly component 10A.

In addition, for example, a bus bar assembly component 10B illustrated in FIGS. 1, 4, and 5 is used for a battery module BM including an electrode terminal group BCc including electrode terminals BCb having a pole shape. The bus bar assembly component 10B includes a plurality of bus bars 11B having a rectangular shape in which two through-holes 11a through which the electrode terminals BCb having a pole shape are inserted are formed, and the respective bus bars 11B are held by a bus bar holding portion 12B formed by insert molding.

The bus bar assembly component 10B can be applied to a battery module BM of another specification as long as the battery module BM includes the electrode terminal group BCc including the electrode terminals BCb having a pole shape. That is, in this case, the bus bar assembly component 10B is a shared bus bar assembly component that can be shared by the battery modules BM of the plurality of specifications including the electrode terminal group BCc. Therefore, when such a bus bar assembly component 10B is shared among the battery modules BM of the plurality of specifications, in the conductive module 1, the plurality of types of bus bar assembly components 10 include the bus bar assembly component 10B as the shared bus bar assembly component. In the conductive module 1, the bus bar assembly component 10 may be configured only by the bus bar assembly component 10B.

Next, the conductive module 1 includes a circuit conductor assembly component 20 including a circuit conductor (not illustrated) for each bus bar 11 that electrically connects the bus bars 11 to the battery monitoring unit (FIGS. 1 to 5). The conductive module 1 includes an electrical connection component (not illustrated, for example, a conductive component such as a terminal fitting or an electric wire) for each bus bar 11, that physically and electrically connects the paired bus bars 11 and the circuit conductor, and electrically connects the bus bars 11 and the circuit conductor.

The circuit conductor assembly component 20 is formed flat along an extending direction of the bus bar assembly component 10 along the bus bar assembly component 10 (FIGS. 1 to 5). Then, for example, the circuit conductor assembly component 20 is held by a rectangular flat plate-shaped conductor holding portion 25 (FIGS. 1 to 5). Although not illustrated, in the conductive module 1, the bus bar holding portion 12 of the bus bar assembly component 10 and the conductor holding portion 25 are held together by a lock mechanism using, for example, a claw portion, and the bus bar assembly component 10 and the circuit conductor assembly component 20 integrated by the lock mechanism are assembled to the battery module BM.

As the circuit conductor assembly component 20, for example, a flexible printed circuit board (FPC) on which a conductor pattern as a circuit conductor is formed for each of the bus bars 11, a rigid substrate on which the conductor pattern as the circuit conductor is formed for each of the bus bars 11, and an electric wire assembly {for example, a bundle of a plurality of electric wires, a flat cable (FC), or the like} including electric wires as the circuit conductors for each of the bus bars 11 are used.

A plurality of types of the circuit conductor assembly components 20 are prepared according to the specification of the battery module BM, and a circuit conductor assembly component that matches the specification of the battery module BM to be connected is assembled to the battery module BM from among the plurality of types.

For example, a circuit conductor assembly component 20A illustrated in FIGS. 1, 2, and 4 is a flexible printed circuit board arranged between the bus bar assembly component 10A and the exhaust duct BMa in the battery module BM1 of FIG. 6 (FIG. 7). When the flexible printed circuit board is used, the circuit conductor assembly component 20 can be classified into, for example, a flexible printed circuit board (one layer of conductor pattern) used when an interval between the bus bar assembly component 10A and the exhaust duct BMa is wide by the exhaust duct BMa having a narrow width, and a flexible printed circuit board (a plurality layers of conductor pattern) used when the interval between the bus bar assembly component 10A and the exhaust duct BMa is narrow by the exhaust duct BMa having a wide width.

The circuit conductor assembly component 20A can be applied to a battery module BM of another specification as long as the interval between the bus bar assembly component 10 and the exhaust duct BMa is the same. That is, in this case, the circuit conductor assembly component 20A is a shared circuit conductor assembly component that can be shared by the battery modules BM of the plurality of specifications having the same interval between the bus bar assembly component 10 and the exhaust duct BMa. Therefore, when such a circuit conductor assembly component 20A is shared among the battery modules BM of the plurality of specifications, in the conductive module 1, the plurality of types of circuit conductor assembly components 20 include the circuit conductor assembly component 20A as the shared circuit conductor assembly component. In the conductive module 1, the circuit conductor assembly component 20 may be configured only by the circuit conductor assembly component 20A.

In addition, for example, a circuit conductor assembly component 20B illustrated in FIGS. 1, 3, and 5 is a flat cable disposed at a position avoiding the restraint member BMb and between two electrode terminal groups BCc2 in the battery module BM2 of FIG. 8 (FIG. 9). The circuit conductor assembly component 20B can be applied to a battery module BM of another specification as long as the arrangement of the restraint member BMb is the same. That is, in this case, the circuit conductor assembly component 20B is a shared circuit conductor assembly component that can be shared by the battery modules BM of the plurality of specifications in which the arrangement of the restraint member BMb is the same. Therefore, when such a circuit conductor assembly component 20B is shared among the battery modules BM of the plurality of specifications, in the conductive module 1, the plurality of types of circuit conductor assembly components 20 include the circuit conductor assembly component 20B as the shared circuit conductor assembly component. In the conductive module 1, the circuit conductor assembly component 20 may be configured only by the circuit conductor assembly component 20B.

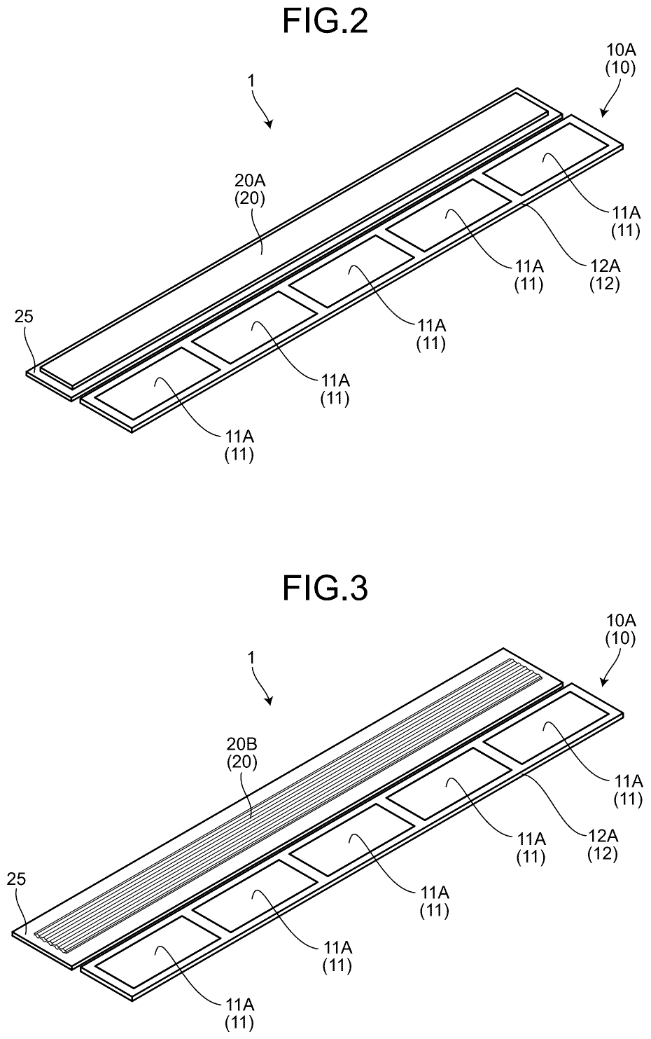

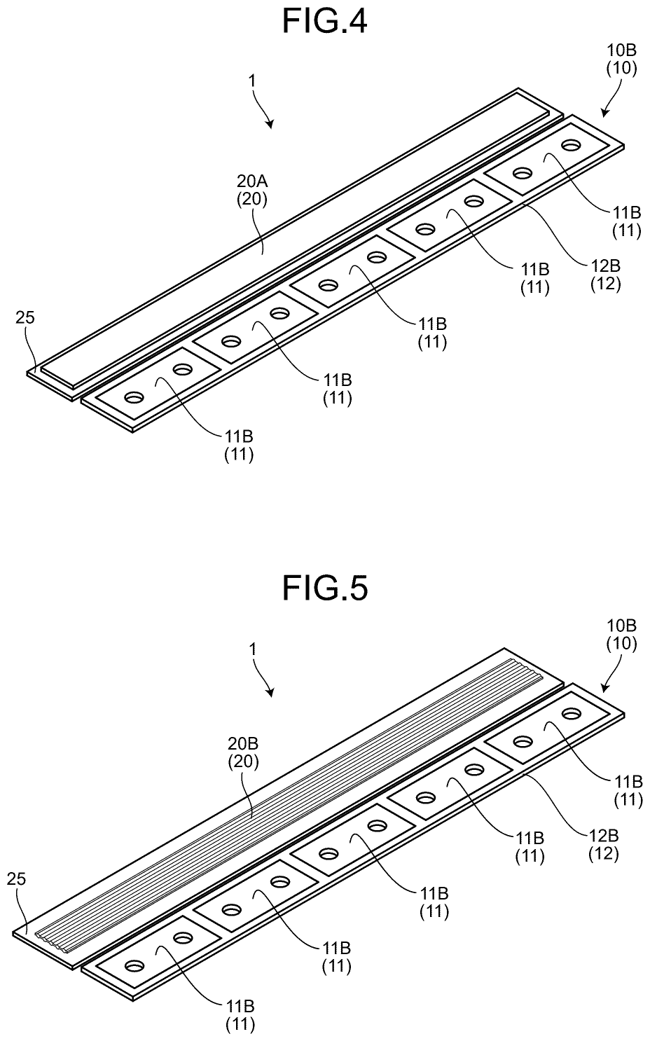

The conductive module 1 illustrated here includes the bus bar assembly component 10A and the bus bar assembly component 10B as the bus bar assembly component 10, and includes the circuit conductor assembly component 20A and the circuit conductor assembly component 20B as the circuit conductor assembly component 20 (FIG. 1). In the conductive module 1, any one of the bus bar assembly component 10A and the bus bar assembly component 10B and any one of the circuit conductor assembly component 20A and the circuit conductor assembly component 20B are combined (FIGS. 2 to 5). FIG. 2 illustrates a combination of the bus bar assembly component 10A and the circuit conductor assembly component 20A. FIG. 3 illustrates a combination of the bus bar assembly component 10A and the circuit conductor assembly component 20B. FIG. 4 illustrates a combination of the bus bar assembly component 10B and the circuit conductor assembly component 20A. FIG. 5 illustrates a combination of the bus bar assembly component 10B and the circuit conductor assembly component 20B.

In the conductive module 1, for example, the bus bar assembly component 10 and the circuit conductor assembly component 20 that are adapted to the arrangement and shape of the exhaust duct BMa in the battery module BM to be connected are combined as objects to be assembled to the battery module BM. In this example, a combination of the bus bar assembly component 10A and the circuit conductor assembly component 20A is assembled to the battery module BM1 of FIG. 6 (FIG. 7).

In addition, in the conductive module 1, for example, the bus bar assembly component 10 and the circuit conductor assembly component 20 that are adapted to the arrangement and shape of the restraint member BMb in the battery module BM to be connected are combined as objects to be assembled to the battery module BM. In this example, a combination of the bus bar assembly component 10A and the circuit conductor assembly component 20B is assembled to the battery module BM2 of FIG. 8 (FIG. 9).

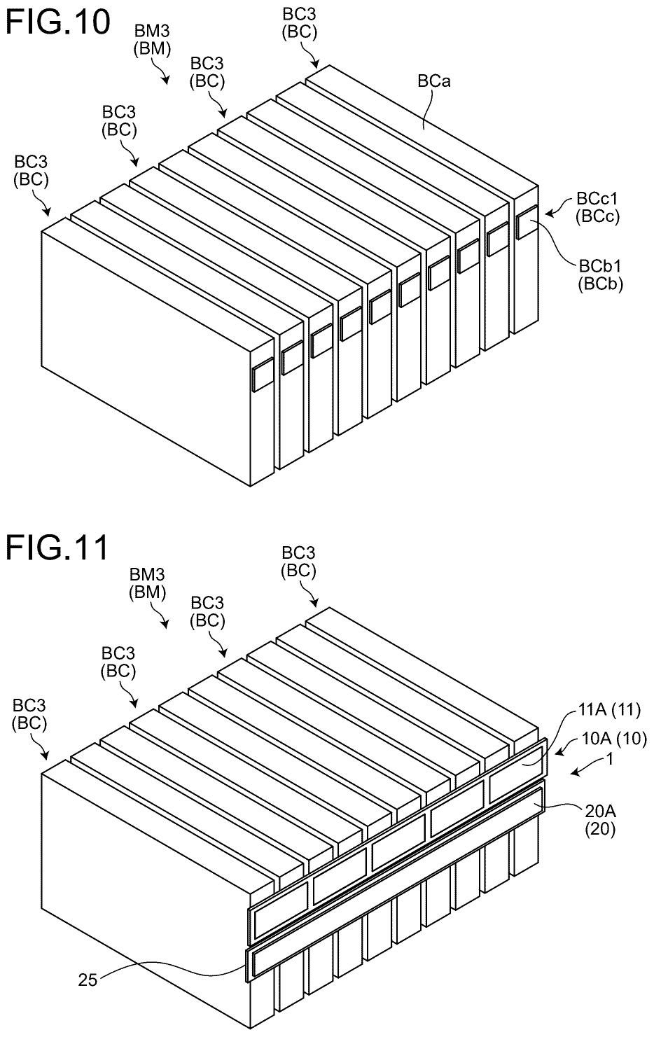

Here, as the battery cell BC, there is known a battery cell BC3 in which a positive electrode flat plate-shaped electrode terminal BCb is provided on one of the six outer wall surfaces of the cell body BCa, and a negative electrode flat plate-shaped electrode terminal BCb is provided on another one of the outer wall surfaces (FIG. 10). The battery module BM3 illustrated in FIG. 10 has a different specification in that a plurality of battery cells BC3 are arranged, and a plane referred to as the side wall surface in the above battery modules BM1 and BM2 is used as the electrode installation surface. In the battery module BM3, one electrode terminal group BCc is provided on each of two side wall surfaces. Here, for convenience, the electrode terminals BCb1 of the battery modules BM1 and BM2 are applied to the respectively positive and negative electrode terminals BCb.

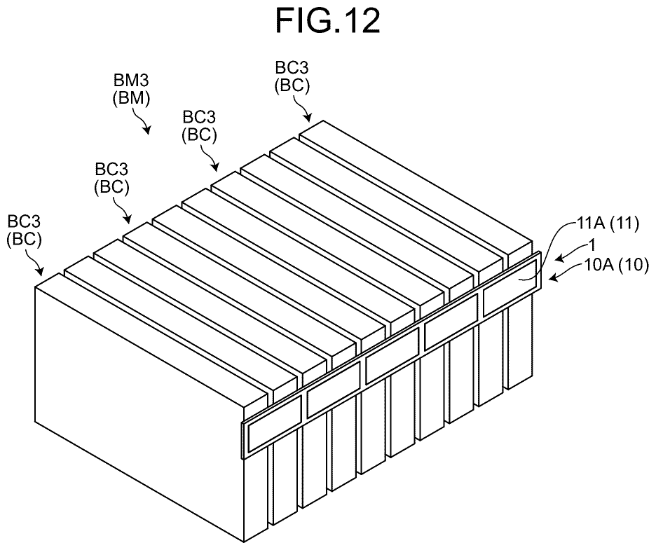

In the conductive module 1, for example, a combination of the bus bar assembly component 10A and the circuit conductor assembly component 20A can be assembled to the battery module BM3 of FIG. 10 (FIG. 11). In the conductive module 1, only the bus bar assembly component 10A can be assembled to the battery module BM3 of FIG. 10 (FIG. 12).

As described above, in the conductive module 1 of the present embodiment, component configurations are roughly divided into the bus bar assembly component 10 and the circuit conductor assembly component 20, and various combinations can be created from among the plurality of types of bus bar assembly components 10 and the plurality of types of circuit conductor assembly components 20 according to the specifications of the battery module BM. In the conductive module 1 of the present embodiment, one bus bar assembly component (shared bus bar assembly component) 10 can be shared among the battery modules BM having different specifications, and one circuit conductor assembly component (shared circuit conductor assembly component) 20 can be shared among the battery modules BM having different specifications. Therefore, the conductive module 1 of the present embodiment can reduce cost by providing cost advantage through component sharing, and by reducing component management cost.

In the conductive module according to the present embodiment, component configurations are roughly divided into a bus bar assembly component and a circuit conductor assembly component, and various combinations can be created from among a plurality of types of bus bar assembly components and a plurality of types of circuit conductor assembly components according to specifications of a battery module. In the conductive module according to the present embodiment, one bus bar assembly component (shared bus bar assembly component) can be shared among battery modules having different specifications, and one circuit conductor assembly component (shared circuit conductor assembly component) can be shared among battery modules having different specifications. Therefore, the conductive module according to the present embodiment can reduce cost by providing cost advantage through component sharing, and by reducing component management cost.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a bus bar assembly component including bus bars that are physically and electrically connected to electrode terminals of one or a pair of battery cells of a battery module in which a plurality of the battery cells are arranged, and a bus bar holding portion that holds a plurality of the bus bars, wherein the bus bar assembly component that matches a specification of the battery module to be connected is assembled to the battery module from among a plurality of types prepared according to the specification of the battery module; and
a circuit conductor assembly component including a circuit conductor for each of the bus bars that electrically connects the bus bars to a battery monitoring unit, wherein the circuit conductor assembly component that matches the specification of the battery module to be connected is assembled to the battery module from among a plurality of types prepared according to the specification of the battery module.

2. The conductive module according to claim 1, wherein
the battery module includes an exhaust duct that communicates with an exhaust valve of each battery cell and releases a gas inside the battery cell discharged from the exhaust valve to an atmosphere, and has a plurality of specifications with different arrangements and shapes of the exhaust duct, and
the bus bar assembly component and the circuit conductor assembly component that are adapted to the arrangement and the shape of the exhaust duct in the battery module to be connected are combined with each other as objects to be assembled to the battery module.

3. The conductive module according to claim 1, wherein
the battery module includes a restraint member that restrains each of the battery cells in an arranged state, and has a plurality of specifications with different arrangements and shapes of the restraint member, and
the bus bar assembly component and the circuit conductor assembly component that are adapted to the arrangement and the shape of the restraint member in the battery module to be connected are combined with each other as objects to be assembled to the battery module.

4. The conductive module according to claim 1, wherein the plurality of types of bus bar assembly components include a shared bus bar assembly component that is able to be shared by the battery modules of the plurality of specifications.

5. The conductive module according to claim 2, wherein the plurality of types of bus bar assembly components include a shared bus bar assembly component that is able to be shared by the battery modules of the plurality of specifications.

6. The conductive module according to claim 3, wherein the plurality of types of bus bar assembly components include a shared bus bar assembly component that is able to be shared by the battery modules of the plurality of specifications.

7. The conductive module according to claim 1, wherein the plurality of types of circuit conductor assembly components include a shared circuit conductor assembly component that is able to be shared by the battery module of the plurality of specifications.

8. The conductive module according to claim 2, wherein the plurality of types of circuit conductor assembly components include a shared circuit conductor assembly component that is able to be shared by the battery module of the plurality of specifications.

9. The conductive module according to claim 3, wherein the plurality of types of circuit conductor assembly components include a shared circuit conductor assembly component that is able to be shared by the battery module of the plurality of specifications.
